(19) United States
(12) Patent Application Publication
(10) Pub. No.: US 2008/0086423 A1
(43) Pub. Date: Apr. 10, 2008

(54) Media player with license expiration warning

(76) Inventor: Nigel Waites, Lakeville, MN (US)

Correspondence Address: BECK AND TYSVER P.L.L.C., 2900 THOMAS AVENUE SOUTH, SUITE 100, MINNEAPOLIS, MN, 55416, US

(21) Appl. No.: 11/973,407

(22) Filed: Oct. 9, 2007

Related U.S. Application Data
(60) Provisional application No. 60/850,317, filed on Oct. 6, 2006.

(51) Int. Cl. H04K 1/00; G08B 3/00; G08B 5/00

(52) U.S. Cl. 705/59; 340/384.5; 340/407.1; 340/815.4

(57) ABSTRACT

A media player is presented that is capable of playing time-limited media files such as those made available through subscription-type digital rights management schemes. Upon accessing a protected media file, the present invention analyzes the appropriate license. If the license has not expired, but will expire soon, the media player will provide a notification of impending expiration to the user immediately before or during the playing of the media file. This notification can be audible, visual, or physical, such as through an audible beep, a visual notification on a display screen, or the activation of a vibration device.

### CLAIM OF PRIORITY

The present invention claims the benefit of U.S. Provisional Application No. 60/850,317, filed on Oct. 6, 2006.

### FIELD OF THE INVENTION

The present invention relates to the field of portable media players capable of handling content protected through digital rights management schemes.

### BACKGROUND OF THE INVENTION

There are currently two primary techniques used in the industry to distribute songs, movies, and other media to consumers while protecting the media through digital rights management (“DRM”) techniques. The first is known as the “purchase” model, and is exemplified by the iTunes music store and the iPod media player, both of which were developed and are distributed by Apple Computer, Inc. (Cupertino, Calif.). In the purchase model, consumers pay a fee for each media file that they download from the distributor. The file is protected by a DRM technique that prevents certain uses of the file. Nonetheless, the user is given an indefinite license play the media file. Since this license does not expire over time, the consumer is given permanent access to the media file even though this access is subject to license and DRM restrictions.

The second distribution scheme is known as the subscription model. In this scheme, a consumer does not pay for the permanent right to access a single file, but rather pays a subscription fee that allows a user to access a large number of files for a limited duration. Providers of subscription services for music media files include the Rhapsody service from RealNetworks Digital Music of California, Inc (San Francisco, Calif.), the Napster service from Napster, LLC (Los Angeles, Calif.), and the Yahoo! Music service from Yahoo! Inc. (Sunnyvale, Calif.). These services each charge a monthly fee to allow unlimited access to their library of media files. The user is allowed to download as many media files as they desire, and can play these files on their computer system using the media player software provided or authorized by the service. In addition, these providers also allow some of the music that has been downloaded to the user's computer to be transferred onto and played upon a portable media player.

The subscription model has certain advantages over the purchase model. In particular, a limited monthly fee often allows a user free access to over one million media files. This access, however, is allowed during those time periods for which the customer has paid the monthly fee. When the subscription lapses, the DRM system prevents the user from playing any of the media files downloaded under the service.

The ability to place a time limit on the ability to play media files has also been used to provide time-limited samples of music. For example, a media player may come pre-loaded with multiple media files that will expire at a set time period if they are not re-authorized by subscribing to a media subscription service. In addition, numerous public libraries in the United States allow audio books to be “check-out” digitally. The media files containing the audio books are downloaded from the Internet subject to a time-limited DRM scheme. The file becomes unplayable after a certain time frame unless the library patron digitally “renews” the files.

### SUMMARY OF THE INVENTION

The present invention media player supports the playing of DRM protected media files. In particular, the media player is capable of playing time-limited media files such as those made available through subscription-type DRM schemes. Upon accessing a protected media file, the present invention media player accesses the appropriate license and compares the time limitation found in the license against a secure clock found on the media player. If the license has expired, the media player will not play the file and will notify the user of a license error. If the license has not expired, but will expire soon, the media player will provide a notification of impending expiration to the user immediately before playing the media file. This notification can be audible, visual, or physical, such as through an audible beep, a visual notification on a display screen, or the activation of a vibration feature on the media player. In the preferred embodiment, an audible tone of approximately 1/10 second duration is played before the media file, accompanied by a warning message on the display screen. If the media player determines that the license is valid and does not soon expire, the media file will play normally without any warning.

### BRIEF DESCRIPTION OF THE DRAWINGS

FIG. 1 is a system diagram showing the environment in which the present invention media player is used, with arrows indicating the movement of license and content data.

FIG. 2 is a system diagram showing the environment of FIG. 1, with arrows indicating the movement of license data when a license is refreshed.

FIG. 3 is a schematic diagram showing the major components of the present invention portable media player.

FIG. 4 is a flow chart showing the method of the present invention.

### DETAILED DESCRIPTION OF THE INVENTION

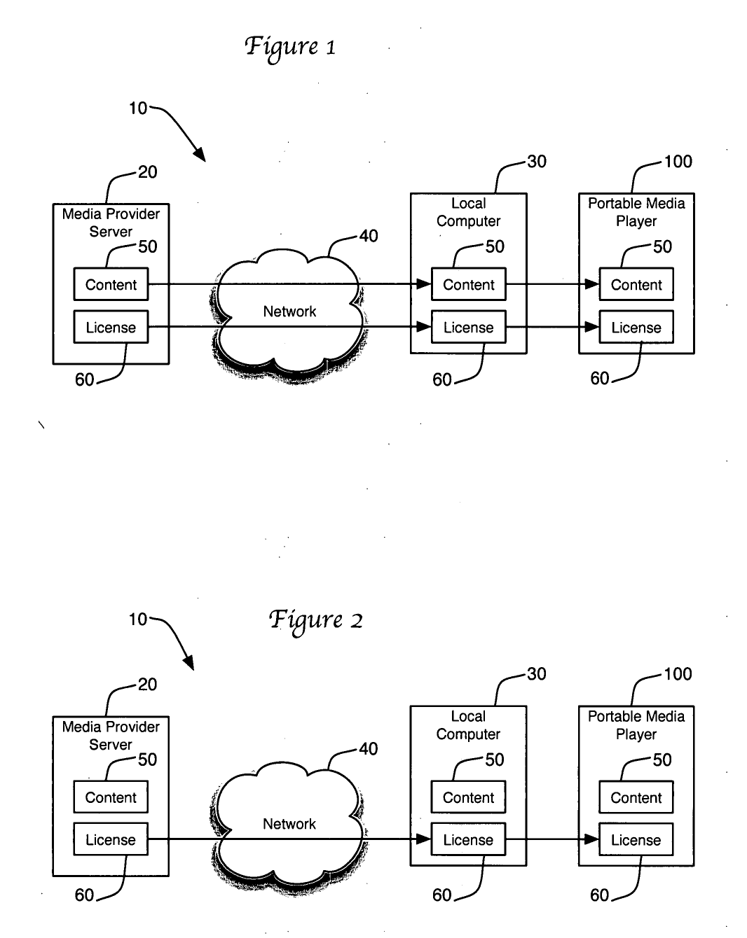

FIG. 1 shows the environment 10 in which a portable media player 100 of the present invention can be used. In this environment, a server 20 operator by a media provider is connected to a plurality of personal computers 30 over a wide area network 40 such as the Internet. Customers of the media provider operate the computers 30 and subscribe to a media provider's service. Consequently, upon payment of a subscription fee, the media provider allows the customer's computer 30 to connect to the media provider's server 20 in order to access media content files 50. These files 50 can contain any audio or visual content, including music files, audio books, photographs, artwork, text documents, music video, television shows, and feature films. These files 50 reside on the server 20, and are downloaded to the computer 30 over the network 40.

In this environment 10, the media content files 50 are protected by a digital rights management scheme that requires a valid license before the media content files 50 can be accessed and enjoyed. In one embodiment, the license takes the form of data 60 that is downloaded from the server 20 along with the content file 50. The license 60 then resides on the computer 30, and is accessed and verified every time the local computer 30 plays the content file 50. Alternatively, the license could be a portion of the content file 50 itself rather than a separate data element 60.

A portable media player 100 connects to the local computer 30 in order to load the content files 50 into the memory of the media player 100. Because the content files 50 are not useable without the licenses 60, the media player 100 also loads these licenses 60. When a content file 50 is played on the media player 100, the license 60 is checked and verified. Only when a valid license 60 is present does the media player 100 play the content file 50.

The connection between the media player 100 and the local computer 30 can take place via known wired or wireless connections, such as USB, Firewire, WiFi, or Bluetooth connections or improvements thereto. In fact, since the method of connection is not directly relevant to the present invention, any type of digital data connection would function adequately.

The ability to play content files 50 protected by licenses 60 does not mean that the media player 100 is unable to play unprotected files. These unprotected files contain media, but are not protected by digital rights management schemes. Consequently, when such a file is to be played, the media player 100 does not need and does not check for a valid license 60.

If all of the protected content files 50 and licenses 60 related to “purchased” or permanently licensed files, the media player 100 will be able to play the content files 50 indefinitely without ever needing to reconnect to the local computer 30. This would also be true if the content files 50 were unprotected by any DRM scheme. However, as explained above, many media providers license their content via subscription services. With these services, the licenses 60 associated with the content files 50 have a limited duration. Once that duration has expired, the licenses 60 are no longer valid and the associated content files 50 can no longer be played. This may occur even when a user is a continuing subscriber to the service. Because a user may cancel their subscription service, media providers cannot provide unlimited duration licenses 60 to the content files 50. Instead, all such licenses 60 are designed to expire, typically within thirty days or less.

To avoid having their licenses expire, users are forced to periodically reconnect their media player 100 to their local computers 30 in order to refresh their licenses. As shown in FIG. 2, new or refreshed licenses 60 are downloaded from the media provider's server 20 over the network 40 and are stored on the local computer 30. This refreshed license 60 is then loaded onto the portable media player 100. In most environments 10, the connecting of the media player 100 to the local computer 30 causes the computer 30 to request updated licenses from the media provider server 20. As can be seen in FIG. 2, this process of refreshing the licenses 60 does not require that the actual content files 50 be re-downloaded from the server 20 or reloaded onto the media player 100, although certain subscription services may require this reloading of content.

Unfortunately, if a user does not re-attach their media player 100 regularly to the local computer 30, it is possible for the licenses 60 to expire even though the user is still a subscriber to the media provider's service. In this event, the content files 50 on the media player 100 become inactive and unplayable.

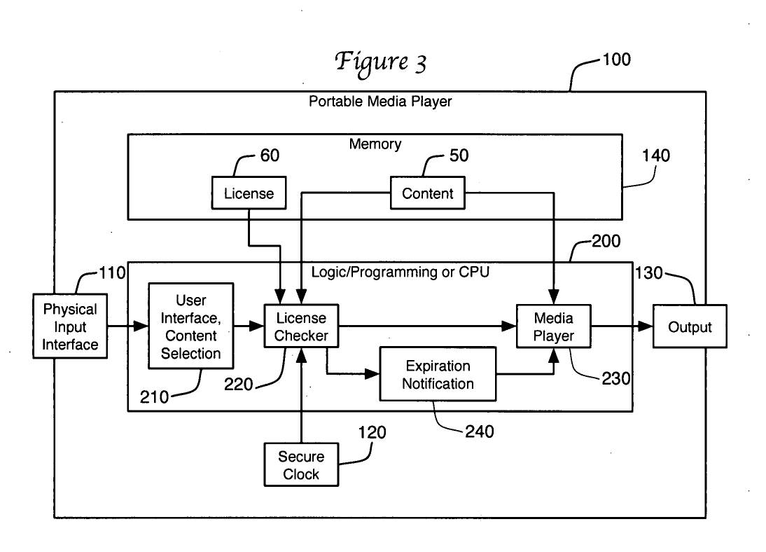

To prevent this from occurring without warning, the portable media player 100 of the present invention is designed to provide a notification to a user whenever a license 60 for a content file 50 is about to expire. To accomplish this, the media player 100 contains the elements shown in FIG. 3. The six main elements found on the media player 100 to achieve this notification are the content file 50, the license 60, a physical user interface 110, a secure clock 120, output mechanism(s) 130, and logic or programming 200. The license 60 and content 50 are stored in memory 140 found in the media player 100. This memory 140 can take any nonvolatile form, such as solid state memory or a small hard disk device.

The physical user interface 100 includes the input user interface used by a user to interact with the media player 100. The physical user interface 110 provides input to the media player 100, and may include buttons, scroll wheels, touch displays, and other inputs such as a USB or IEEE 1394 data input ports. The entire interface experience of the user is a combination of the input physical interface 100 and the output interface 130. The output interface 130 may include a display screen, an audio jack (such as a headphone jack), a speaker, a vibration device, or other output devices.

The logic 200 can be stored in the same memory as the content 50 or license 60, or can be permanently stored in a programmable logic device. Regardless of how the logic 200 is stored, digital electronic processing is required to execute the logic 200. This processing can take place in a central processing unit, such as CPU or within a dedicated logic device. This processor can be considered to physically implement the logic 200, and thus is also shown in FIG. 3 as element 200.

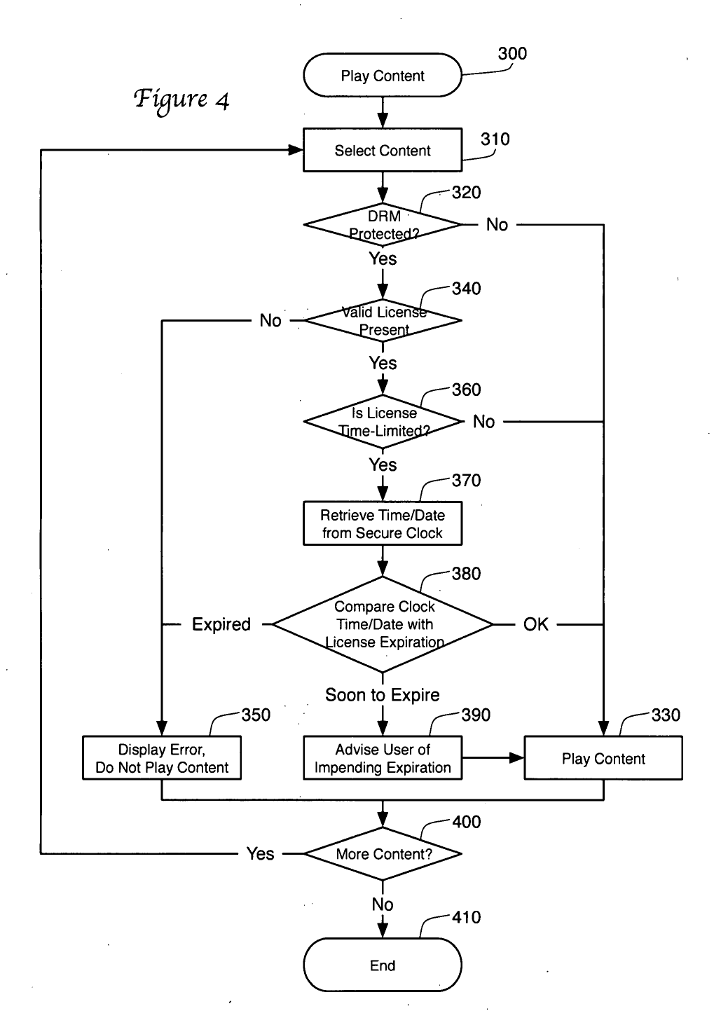

The logic or programming 200 used to play content files 50 is divided into individual components 210-240 in FIG. 3, and is presented as method 300 in the flowchart shown in FIG. 4. The logic 200 receives instructions to play a particular content file 50 from the physical user interface 110 at programming component 210. This component 210 is responsible for interacting with the user via the user interface 110, and for selecting the content files 50 that are to be played by the portable media player 100. This is shown as step 310 in FIG. 4.

When a content file 50 is selected the license checker component 220 of logic 200 determines whether the selected content file is properly licensed. To accomplish this, the license checker 220 first determines if the content 50 is protected by a DRM system (step 320). If not, the content 50 can be played by the media player component 230 and output to the user through output mechanisms 130 (at step 330). If the content 50 is protected, the license checker 220 attempts to locate the license 60 that is applicable for the content file 50 (step 340). If no license 60 for the content can be found, an error is displayed at output 130 indicating that the content 50 is unlicensed and cannot be played (step 350).

If a license 60 is found, the license checker component 220 analyzes the license to determine whether it is a permanent license (which would be the case if the content 50 was “purchased”), or whether the license 60 is time limited (which would be the case if the content 50 was obtained through a subscription service). The analysis is done at step 360. If the license is not time limited, then the license 60 is valid and the content is played by the media player component 230 at step 330. If the license is time limited, the license checker component 220 retrieves time and date information from the secure clock 120 (step 370) and compares this information with the expiration information found in license 60. This comparison, at step 380, can lead to three possibilities. The first is that the license 60 has expired. In this case, an error is displayed indicating that the license has expired at step 350, and the content is not played. The second option is that the license 60 has not expired, and will not expire in the near future. In this case, the content will be played at step 330.

The third possibility is that the license has not yet expired, but will expire soon. In this case, the license checker 220 triggers the expiration notification component 240 of the media player logic 200. This component causes the media player 100 to provide a warning to the user through one or more of the output mechanisms 130. This notification informs the user that the license 60 to play the selected content 50 will soon expire, and is shown in method 300 at step 390. Once this notice is given, the media player component 230 will play the content 50 at step 330.

The form of the notification provided at step 390 can vary depending upon the abilities of the media player 100, the programming decisions made in the development of component 240, and the choices made by the user. In the preferred embodiment, a tone or beep signal is played for approximately 1/10 second before the media player 100 plays the content 50. This tone informs the user that the next content file 50 to be played will soon expire, and that the media player 100 should be reconnected to computer 30 to refresh the licenses 60. In addition to this tone, the preferred embodiment displays a warning message on a visual display (one of the output mechanisms 100) explaining the need to refresh the license 60. The duration of the message on the visual display could be selected by the user. For instance, the message could precede the playing of the content file 50, and be removed once the content file 50 beings to play. Alternatively, the warning message could be shown for a set time period during the playback of file 50. For example, the message could be displayed as soon as the determination 380 is made, and could remain on the screen through the first five seconds of playing content 50.

As a third alternative, the message could remain on the screen during the entire playback of content 50. In this case, it would be preferable if the imminent license expiration message does not completely interfere with the normal visual display that takes place during content playback. For example, a short message could appear on the top or bottom of the display while the rest of the display contains information about content file 50 and the playing process. The “message” need not include words, as a simple logo, colored dot, background color, or even font typeface change may be sufficient to prompt the user to refresh the license 60.

In yet another embodiment, the media player 100 advises the user of impending expiration at step 390 by causing the player 100 to undergo some physical change. For example, many portable electronic devices include a vibration mechanism that is used to signal the user, such as a vibration used to indicate an incoming call on a cellular phone. In a similar way, the expiration notification component 240 of logic 200 could cause the media player 100 to vibrate at the beginning of every song played when the license for that song will soon expire.

In many cases, a user of the media player 100 will have many licenses 60 with the same expiration date. Consequently, the warning beeps, messages, or vibrations may end up getting repeated before most every song. The preferred embodiment therefore can provide users the option of only presenting the warning before every X number of songs, or only once every X minutes (where the variable X is selected by the user in the preference settings for the player 100). This setting can apply to all warnings, or to only audible or vibration warnings. If audible and vibration warnings are selected, the visual warnings on the display might still be given for each song whose license is soon to expire.

The determination of when a license is “soon” to expire is also best left up to user preference settings. A default value, such as three days, could be provided to the system to ensure that the warning will be given even if the user has not set any preference values. The user could then set the time period for determining when the soon-to-expire warning should be given.

Whether the content is played at step 330 or an error message is displayed at step 350, the method 300 continues with a determination as to whether additional content 50 is to be played. This determination is made at step 400 by the user interface component 210. If more content 50 is to be played, the process 300 returns to the content selection step 310. If not, the process ends at step 410.

The many features and advantages of the invention are apparent from the above description. Numerous modifications and variations will readily occur to those skilled in the art. For instance, the digital rights management scheme described above located license information in locally stored data that was separated from the media content file 50. However, other licensing embodiments that do not locate license information in local data separated from the content files are known and can be used with the present invention. For instance, license information can be permanently affixed to or embedded within the content files 50. Alternatively, the licensing information can be located remote from the local computer, with the license comparison being performed by accessing the remotely located licensing data when the media content file 50 is to be played. In a still further embodiment of a DRM scheme, there may be no need to access actual licensing data every time a content file 50 is played. All that is necessary is that the player responsible for playing the content file 50 is able to access licensing status information when playing the file 50. All of these generally defined DRM schemes are contemplated as useable with the present invention media player, and are therefore within the intended scope of the present invention. In addition, the above description assumed that the media player 100 is connected to a local computer 30 to download content files 50 and to download or update licenses 60. However, it is well within the scope of the present invention for the media player 100 to directly connect to the media provider server 20 through the network 40 without going through a local computer 30. Since such modifications are possible, the invention is not to be limited to the exact construction and operation illustrated and described. Rather, the present invention should be limited only by the following claims.

What is claimed is:

1. A portable media player comprising:
a) a memory containing
i) content, and
ii) a license associated with the content, the license having an expiration time;
b) a clock;
c) an expiration notification logic component that provides notification external to the portable media player if the clock indicates that the license has not yet expired but will expire within a predetermined time frame.

2. The portable media player of claim 1, wherein the notification is of a form chosen from the set of: an audible signal on an audible output mechanism of the media player, a visual signal displayed on a visual output mechanism on the media player, and a vibration created by a vibration device found in the media player.

3. The portable media player of claim 1, wherein the license is data stored separately from the content.

4. The portable media player of claim 1, wherein the license forms a portion of the data file containing the content.

5. The portable media player of claim 1, wherein the memory is a nonvolatile memory.

6. A method for verifying a time limited license for media content on a portable media player comprising:
a) analyzing a license for a media product about to be played;
b) determining whether the license will expire within a predetermined time frame but has not yet expired; and
c) if the determination in step b) is positive, creating a notification detectable outside of the media player indicated that the license for the media content will soon expire.

7. The method of claim 6, wherein the step of creating a notification takes the form of creating an audible signal on an audible output mechanism of the media player.

8. The method of claim 6, wherein the step of creating a notification takes the form of creating a visual signal displayed on a visual output mechanism on the media player.

9. The method of claim 6, wherein the step of creating a notification takes the form of creating a vibration by triggering by a vibration device found in the media player.
